(19) United States
(12) Patent Application Publication
(10) Pub. No.: US 2006/0161438 A1
(43) Pub. Date: Jul. 20, 2006

(54) Hybrid-parameter mode speech synthesis system and method

(75) Inventor: Hong-Mao Lu, Hukou Township (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/234,193

(22) Filed: Sep. 26, 2005

(30) Foreign Application Priority Data
Jan. 20, 2005 (TW) 094101676

(51) Int. Cl. G10L 13/06

(52) U.S. Cl. 704/266

(57) ABSTRACT

A hybrid-parameter mode speech synthesis system includes a sample unit corpus storing multiple sample speech units, an indirect unit corpus storing indirect parameter sequences of partial synthesis speeches, a synthesis parameter database storing parameter sequences of various synthesis speeches, and a speech synthesizer. The speech synthesizer is used for retrieving a parameter sequence of the synthesis speech for an inputted word from the synthesis parameter database, so as to retrieve the indirect parameter sequence of the corresponding partial synthesis speech from the indirect unit corpus according to each indirect parameter set of the parameter sequence, thereby combining the basic parameter sets included in the indirect parameter sequence into the at least one basic parameter set included in the parameter sequence, and processing a speech synthesis procedure based on the combined basic parameter set.

### BACKGROUND OF THE INVENTION

1. Field of the Invention

The present invention relates to a speech synthesis device, and more particularly, to a hybrid-parameter mode speech synthesis system and method.

2. Description of Related Art

In order to enhance the quality of speech synthesis in the current speech synthesis scheme, synthesis parameters are usually adjusted to be the best for being recorded in advance if the corpus is constant. With reference to FIG. 1, it illustrates a conventional speech synthesis system. A synthesis parameter database 11 stores a variety of parameter sequences 111 for synthesis speech, wherein each parameter sequence 111 comprises at least one parameter set 112 of the synthesis speech, and each parameter set 112 includes code uₓ, speech unit energy variation, speech unit duration variation, and speech unit tone variation of the to-be-selected speech unit. If an inputted word W is going to be synthesized, the speech synthesizer 12 firstly retrieves the parameter sequence 111 of the synthesis speech for the word W from the synthesis parameter database 11, and then retrieves a corresponding sample speech unit Uₓ from the sample unit corpus 13, which stores a plurality of pre-recorded sample speech units Uₓ, based on the code uₓ of the speech unit included in each parameter set 112 of the parameter sequence 111. Consequently, by adjusting corresponding parameters such as speech unit energy variation, speech unit duration variation, and speech unit tone variation, all retrieved speech units Uₓ are synthesized and outputted as a synthesis speech signal s(t).

As an example, if the inputted word W is ‘addition’, the speech synthesizer 12 retrieves the following parameter sequence of the synthesis speech for the word ‘addition’ from the synthesis parameter database 11:
{(u₁, . . . ) (u₂, . . . ) (u₃, . . . ) (u₄, . . . ) (u₅, . . . )},
wherein (uᵢ, . . . ) is one of the parameter sets, and uᵢ is the code of the speech unit. Then, corresponding sample speech units U₁˜U₅ (each respectively corresponds to the pronunciation of ‘a’, ‘di’, ‘t’, ‘io’, and ‘n’) are retrieved from the sample unit corpus 13 according to the codes u₁˜u₅ of the speech unit included in each parameter set of the parameter sequence. Thereby the following synthesis speech signal s(t) is synthesized and outputted:
s(t)=synth(U₁) & synth(U₂) & synth(U₃) & synth(U₄) & synth(U₅),
wherein synth( ) represents the synthesizer, and ‘&’ represents the time connection between speech signals.

However, in the aforementioned conventional speech synthesis system, the implementation of directly storing synthesis parameters in the synthesis parameter database 11 is inefficient because the statistical characteristic of speech signals is an uneven distribution, such as certain specific pronunciation modes are frequently used.

Therefore, it is desirable to provide an improved hybrid-parameter mode speech synthesis system and method to mitigate and/or obviate the aforementioned problems.

### SUMMARY OF THE INVENTION

The object of the present invention is to provide a hybrid-parameter mode speech synthesis system and method, which can reduce the storage space occupied by synthesis parameters, and increase sample speech units of the sample unit corpus.

To achieve these and other objects of the present invention, the hybrid-parameter mode speech synthesis system comprises a sample unit corpus, an indirect unit corpus, a synthesis parameter database, and a speech synthesizer. The sample unit corpus stores multiple pre-recorded sample speech units. The indirect unit corpus stores indirect parameter sequences of various partial synthesis speeches, wherein each indirect parameter sequence includes multiple basic parameter sets of its partial synthesis speech. The synthesis parameter database stores parameter sequences of various synthesis speeches, wherein each parameter sequence includes at least one basic parameter set or indirect parameter set. Each basic parameter set includes a code of a to-be-selected speech unit; and each indirect parameter set represents the indirect parameter sequence of a corresponding partial synthesis speech stored in the indirect unit corpus. The speech synthesizer is used for retrieving a parameter sequence of the synthesis speech for an inputted word from the synthesis parameter database, so as to retrieve the indirect parameter sequence of the corresponding partial synthesis speech from the indirect unit corpus according to each indirect parameter set of the parameter sequence. Therefore, the basic parameter sets of the indirect parameter sequence are combined with the at least one basic parameter set of the parameter sequence as a combined basic parameter, and processing a speech synthesis procedure based on the combined basic parameter set.

According to another aspect of the present invention, the hybrid-parameter mode speech synthesis method applied in the above speech synthesis system comprises the steps of: (A) retrieving a parameter sequence of the synthesis speech for an inputted word from the synthesis parameter database; (B) retrieving the indirect parameter sequence of the corresponding partial synthesis speech from the indirect unit corpus according to each indirect parameter set of the parameter sequence; and (C) combining the basic parameter sets included in the indirect parameter sequence into the at least one basic parameter set included in the parameter sequence as a combined basic parameter set so as to process a speech synthesis procedure based on the combined basic parameter set.

Other objects, advantages, and novel features of the invention will become more apparent from the following detailed description when taken in conjunction with the accompanying drawings.

### BRIEF DESCRIPTION OF THE DRAWINGS

FIG. 1 illustrates a system structure of a conventional speech synthesis system;

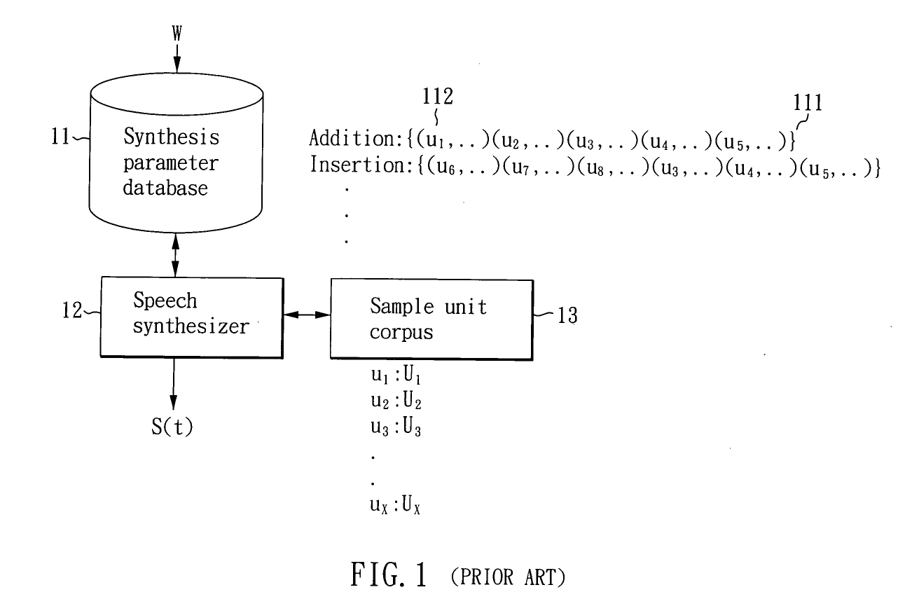

FIG. 2 illustrates a system structure of a hybrid-parameter mode speech synthesis system of the preferred embodiment according to the present invention;

FIG. 3 is a flowchart of the hybrid-parameter mode speech synthesis method of the preferred embodiment according to the present invention; and

FIG. 4 depicts one example for speech synthesis of the preferred embodiment according to the present invention.

### DETAILED DESCRIPTION OF THE PREFERRED EMBODIMENT

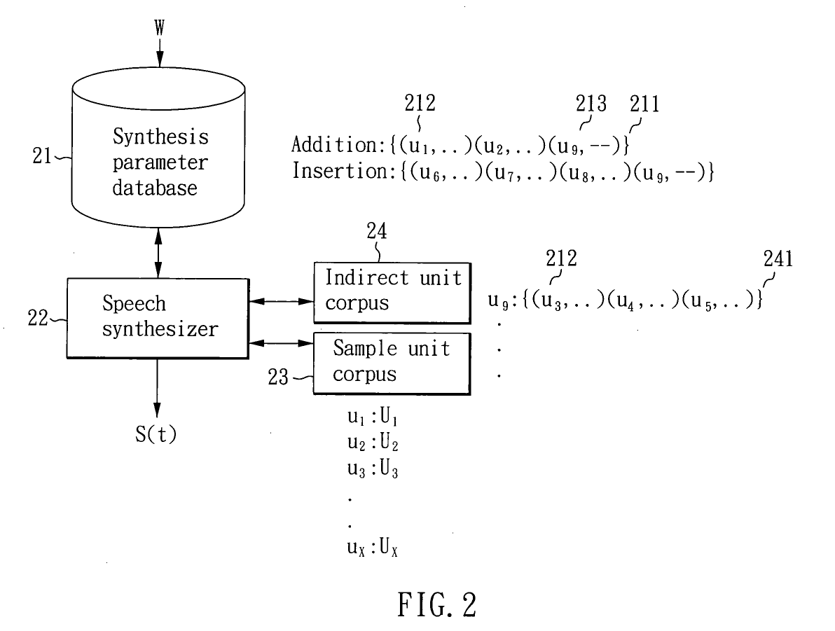

Please refer to FIG. 2. FIG. 2 illustrates a system structure of a hybrid-parameter mode speech synthesis system of the preferred embodiment according to the present invention. As shown in FIG. 2, this embodiment comprises: a synthesis parameter database 21, a speech synthesizer 22, a sample unit corpus 23, and an indirect unit corpus. The synthesis parameter database 21 stores parameter sequences 211 of a variety of synthesis speeches, and each parameter sequence 211 includes at least one parameter set of its corresponding synthesis speech. The sample unit corpus 23 stores multiple pre-recorded sample speech units U₁-Uₓ. The above indirect unit corpus 24 stores indirect parameter sequences 241 of a variety of partial synthesis speeches. In this embodiment, each common synthesis parameter sequence (corresponding to a partial synthesis speech) is regarded as an indirect unit based on statistical algorithms, and these common synthesis parameter sequences are stored as an indirect parameter sequence 241, wherein each indirect parameter sequence 241 comprises multiple basic parameter sets 212 of its corresponding partial synthesis speech and/or other indirect parameter sets 213. Each basic parameter set 212 includes code uₓ, speech unit energy variation parameters, speech unit duration variation parameters, and speech unit tone variation parameters of the to-be-selected speech unit.

By providing the indirect unit corpus 24, the parameter set included in the parameter sequence 211 of the synthesis speech of the aforementioned synthesis parameter database 21 can be a basic parameter set 212 or an indirect parameter set 213. Each basic parameter set 212 includes code uₓ, speech unit energy variation parameters, speech unit duration variation parameters, and speech unit tone variation parameters of the to-be-selected speech unit Uₓ; each indirect parameter set 213 represents the indirect parameter sequence 241 of a corresponding partial synthesis speech stored in the indirect unit corpus 24. Consequently, in the synthesis parameter database 21, the parameter sequence 211 stored in the synthesis speech, which includes partial synthesis speech corresponding to the indirect parameter sequence 241, is composed of both basic parameter sets 212 and indirect parameter sets 213 corresponding to the indirect parameter sequence 241, not only composed of basic parameter sets 212, thereby reducing the data stored in the synthesis parameter database 21.

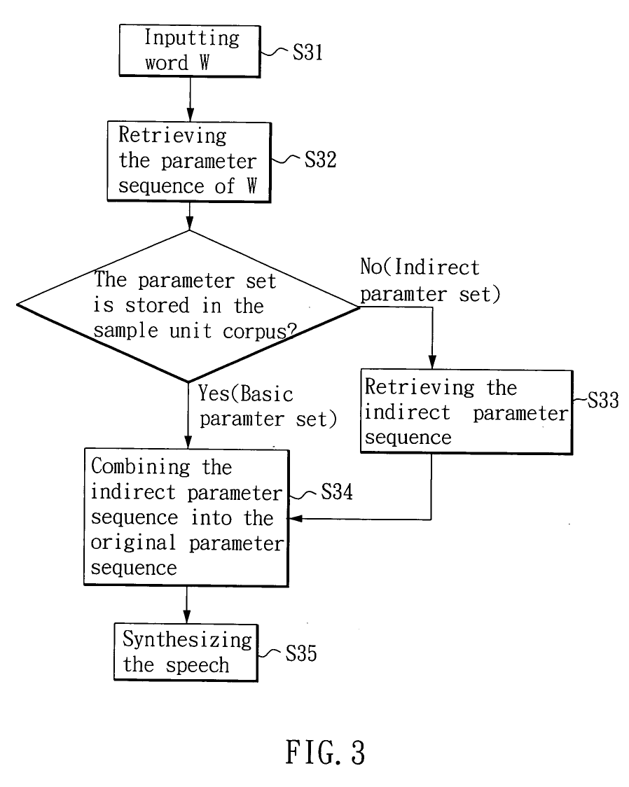

The aforesaid speech synthesizer 22 is a signal processor for processing the speech synthesis procedure. Please refer to the flowchart illustrated in FIG. 3, when an inputted word W is going to be synthesized (S31), the speech synthesizer 22 retrieves the parameter sequence 21 of the synthesis speech of the inputted word W from the synthesis parameter database 21 (S32). If the parameter set of the parameter sequence 211 is stored in the sample unit corpus 23, the parameter set is the basic parameter set 212; otherwise, the parameter set is the indirect parameter set 213. Next, the speech synthesizer 22 retrieves the indirect parameter sequence 241 of the corresponding partial synthesis speech from the indirect unit corpus 24 according to each indirect parameter set of the parameter sequence 211 (S33). Then, the speech synthesizer 22 combines the basic parameter set 212 of the indirect parameter sequence 241 into the basic parameter set 212 of the aforementioned parameter sequence 211 (S34). The speech synthesizer 22 further retrieves corresponding sample speech unit Uₓ from the sample unit corpus 23 according the code uₓ of the speech unit included in the combined basic parameter set 212, so as to process a speech synthesis procedure for the retrieved speech unit Uₓ by adjusting the speech unit energy variation parameters, speech unit duration variation parameters, and speech unit tone variation parameters, thereby outputting a synthesis speech signal s(t) (S35).

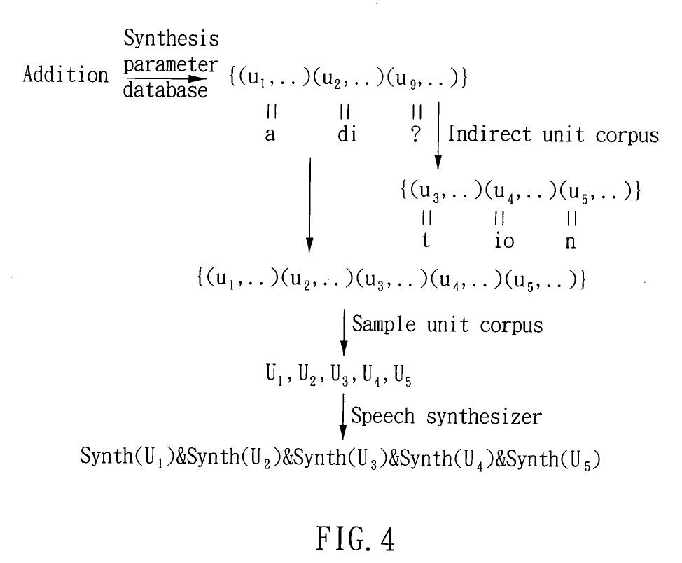

With reference to FIG. 4, if the inputted word W is ‘addition’, the speech synthesizer 22 retrieves the parameter sequence {(u₁, . . . ) (u₂, . . . ) (u₉, . . . )} of the synthesis speech for the word ‘addition’ from the synthesis parameter database 21. Because code u₉ of the speech unit in the parameter sequence does not exist in the sample unit corpus 23, it is known that (u₉, . . . ) shall be an indirect parameter set 213. Therefore the speech synthesizer 22 retrieves the indirect parameter sequence 241 {(u₃, . . . ) (u₄, . . . )(u₅, . . . )} of its corresponding partial synthesis speech (‘tion’) from the indirect unit corpus 24. Then, the speech synthesizer 22 combines the basic parameter sets (u₃, . . . ), (u₄, . . . ), and (u₅, . . . ) included in the indirect parameter sequence 241 into the basic parameter sets (u₁, . . . ) and (u₂, . . . ) of the aforementioned parameter sequence 211. As a result, the corresponding sample speech units U₁˜U₅ can be retrieved from the sample unit corpus 23 according to the codes u₁˜u₅ of the speech units included in the combined basic parameter set (u₁, . . . ), (u₂, . . . ), (u₃, . . . ), (u₄, . . . ), and (u₅, . . . ). Thereby all retrieved speech units are synthesized and outputted as the following synthesis speech signal s(t) by adjusting the corresponding speech unit energy variation parameters, speech unit duration variation parameters, and speech unit tone variation parameters:
s(t)=synth(U₁) & synth(U₂) & synth(U₃) & synth(U₄) & synth(U₅),
wherein synth( ) represents the synthesizer, and ‘&’ represents the time connection between speech signals.

According to the description mentioned above, the present invention constructs an indirect parameter sequence by combining the parameters of common partial synthesis speeches, and records these indirect parameter sequences so as to establish an indirect unit corpus 24. In practical application, the system firstly determines whether the parameter set included in the parameter sequence of the synthesis speech is an indirect parameter set. If the parameter set is the basic parameter set, the system directly retrieves the sample speech unit from the sample unit corpus 23. Otherwise, if the parameter set is the indirect parameter set, the system firstly returns the parameter set to the basic parameter sequence according to the indirect unit corpus 24, and then processes the speech synthesis procedure according to the basic parameter sets. Consequently, for many synthesis speech signals with identical parts, such as ‘addition’ and ‘insertion’, the identical parts (e.g. ‘tion’) are stored as indirect parameter sequences in the indirect unit corpus 24, so as to reduce the storage space occupied by synthesis parameters, and increase sample speech units of the sample unit corpus. Further, the indirect parameter sequence 241 can also include other indirect parameter sets, which can be returned to basic parameter sequences by repeating the aforesaid method, thereby enhancing the effect of the present invention.

Although the present invention has been explained in relation to its preferred embodiment, it is to be understood that many other possible modifications and variations can be made without departing from the spirit and scope of the invention as hereinafter claimed.

What is claimed is:

1. A hybrid-parameter mode speech synthesis system, comprising:
a sample unit corpus, which stores multiple pre-recorded sample speech units;
an indirect unit corpus, which stores indirect parameter sequences of a plurality of partial synthesis speeches, each indirect parameter sequences including multiple basic parameter sets of its corresponding partial synthesis speech;
a synthesis parameter database, which stores parameter sequences of a plurality of synthesis speeches, each parameter sequence including at least one basic parameter set or indirect parameter set of its corresponding synthesis speech, each basic parameter set including a code of a to-be-selected speech unit, each indirect parameter set representing the indirect parameter sequence of a corresponding partial synthesis speech stored in the indirect unit corpus; and
a speech synthesizer for retrieving a parameter sequence of the synthesis speech for an inputted word from the synthesis parameter database, so as to retrieve the indirect parameter sequence of the corresponding partial synthesis speech from the indirect unit corpus according to each indirect parameter set of the parameter sequence, thereby combining the basic parameter sets included in the indirect parameter sequence into the at least one basic parameter set included in the parameter sequence as a combined basic parameter set, and processing a speech synthesis procedure based on the combined basic parameter set.

2. The system as claimed in claim 1, wherein the speech synthesizer retrieves a corresponding sample speech unit from the sample unit corpus according to the code of the speech unit included in the combined basic parameter set, so as to synthesize all retrieved speech units for outputting a synthesis speech signal.

3. The system as claimed in claim 1, wherein each basic parameter set further comprises speech unit energy variation parameters, speech unit duration variation parameters, and speech unit tone variation parameters.

4. The system as claimed in claim 3, wherein the speech synthesizer synthesizes all retrieved speech units for outputting a synthesis speech signal by adjusting the speech unit energy variation parameters, speech unit duration variation parameters, and speech unit tone variation parameters.

5. The system as claimed in claim 1, wherein each indirect parameter sequence further comprises other indirect parameter sets.

6. A hybrid-parameter mode speech synthesis method applied in a speech synthesis system including a sample unit corpus, an indirect unit corpus and a synthesis parameter database, the sample unit corpus storing multiple pre-recorded sample speech units, the indirect unit corpus storing indirect parameter sequences of a plurality of partial synthesis speeches, each indirect parameter sequences including multiple basic parameter sets of its corresponding partial synthesis speech, the synthesis parameter database storing parameter sequences of a plurality of synthesis speeches, each parameter sequence including at least one basic parameter set or indirect parameter set of its corresponding synthesis speech, each basic parameter set including a code of a to-be-selected speech unit, each indirect parameter set representing the indirect parameter sequence of a corresponding partial synthesis speech stored in the indirect unit corpus, the method comprising the steps of:
(A) retrieving a parameter sequence of the synthesis speech for an inputted word from the synthesis parameter database;
(B) retrieving the indirect parameter sequence of the corresponding partial synthesis speech from the indirect unit corpus according to each indirect parameter set of the parameter sequence; and
(C) combining the basic parameter sets of the indirect parameter sequence into the at least one basic parameter set of the parameter sequence as a combined basic parameter set so as to process a speech synthesis procedure based on the combined basic parameter set.

7. The method as claimed in claim 6, wherein in step (C), the speech synthesis procedure retrieves a corresponding sample speech unit from the sample unit corpus according to the code of the speech unit included in the combined basic parameter set, so as to synthesize all retrieved speech units for outputting a synthesis speech signal.

8. The method as claimed in claim 6, wherein each basic parameter set further comprises speech unit energy variation parameters, speech unit duration variation parameters, and speech unit tone variation parameters.

9. The method as claimed in claim 8, wherein in step (C), the speech synthesis procedure synthesizes all retrieved speech units for outputting a synthesis speech signal by adjusting the speech unit energy variation parameters, speech unit duration variation parameters, and speech unit tone variation parameters.

10. The method as claimed in claim 6, wherein each indirect parameter sequence further comprises other indirect parameter sets.
